(19) United States
(12) Patent Application Publication
(10) Pub. No.: US 2024/0187868 A1
(43) Pub. Date: Jun. 6, 2024

(54) TRANSLATION MATRIX USER PORTAL TO SIMPLIFY ONBOARDING SLICES

(71) Applicant: RAKUTEN MOBILE, INC., Tokyo (JP)

(72) Inventors: Jithin CHATHANKANDATH, Tokyo (JP); Surender LAMBA, Tokyo (JP)

(73) Assignee: RAKUTEN MOBILE, INC., Tokyo (JP)

(21) Appl. No.: 17/799,183

(22) PCT Filed: Jul. 11, 2022
(86) PCT No.: PCT/US2022/036625

§ 371 Date: Aug. 11, 2022

(51) Int. Cl. H04W 16/18; H04L 41/085; H04L 41/12; H04L 41/22

(52) U.S. Cl. CPC H04W 16/18; H04L 41/085; H04L 41/12; H04L 41/22

(57) ABSTRACT

A method for onboarding a network slice associated with a wireless network includes providing an onboarding graphical user interface (GUI). The method further includes receiving, from the onboarding GUI, a network slicing topology that specifies one or more network nodes of the wireless network. The method further includes configuring, through the onboarding GUI based on information retrieved from one or more registration databases, the network slicing topology. The method further includes defining, through the onboarding GUI, one or more network slice workflows based on the configuring. The method further includes generating, through the onboarding GUI, a network slice bundle based on the one or more network slice workflows. The method further includes registering, through the onboarding GUI, the network slice bundle with the one or more registration databases for deployment of the network slice on the wireless network.

### TECHNICAL FIELD

The present disclosure relates generally to communication systems, and more particularly to methods and apparatuses for onboarding network slices.

### BACKGROUND

Related communication systems, such as wireless communication systems (e.g., 4G, Long Term Evolution (LTE), 5G) may be deployed to provide various telecommunication services such as telephony, video, data, messaging, and broadcasts. In order to meet ever increasing demands for wireless data traffic, network technologies may seek to implement an end-to-end (E2E) system in which all targets are integrated over a network providing access in a wired manner, a wireless manner, or other various schemes. To that end, standardization organizations (e.g., International Telecommunication Union (ITU), Next Generation Mobile Networks (NGMN) Alliance, Third Generation Partnership Project (3GPP), Internet Engineering Task Force (IETF)) may define and/or design system and/or network architectures to implement network technologies that may feature high performance, low latency, and high availability.

One such network technology may involve the adoption of network slicing for radio access networks (RANs) and core networks (CNs) that are interconnected to each other via transport networks (TNs). Under network slicing, network resources and network functions may be bundled into network slices depending on individual services, service level agreements (SLAs), and/or network path routing to be provided by each network slice. That is, a network slice over a communication network may provide customized network services by combining control plane (CP) and user plane (UP) network functions for network services necessary for a particular service over a CN and a RAN.

However, setting up and deploying a network slice is a time consuming process for both network vendors offering a network service and network operators deploying the network slice. Particularly, onboarding a network slice requires (i) the network vendor to specify multiple configurations for multiple network domains, and (ii) the network operator to set up the configurations for each domain at specified timings. In this regard, related mechanisms for deploying and implementing network slicing functionality across network domains may rely on the use of different network slice subnet management function (NSSMF) devices for each domain. For example, each of the RAN, CN, and TN domains may each independently implement separate NSSMF devices (e.g., RN-NSSMF, CN-NSSMF, and TN-NSSMF, respectively).

As such, each domain (e.g., RAN, CN, and TN) requires separate configurations for each slice. Furthermore, the configurations and workflows are specific to each network vendor and therefore, are generally not reusable for another network vendor. As a result, onboarding a network slice for each network vendor is a time consuming and inefficient process. Thus, there exists a need for further improvements in onboarding network slices for 5G networks. Improvements are presented herein. These improvements may also be applicable to other multi-access technologies and the telecommunication standards that employ these technologies.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present disclosure in a simplified form as a prelude to the more detailed description that is presented later.

Methods, apparatuses, and non-transitory computer-readable mediums for onboarding network slices are disclosed by the present disclosure.

According to exemplary embodiments, a method for onboarding a network slice associated with a wireless network includes providing an onboarding graphical user interface (GUI). The method further includes receiving, from the onboarding GUI, a network slicing topology that specifies one or more network nodes of the wireless network. The method further includes configuring, through the onboarding GUI based on information retrieved from one or more registration databases, the network slicing topology. The method further includes defining, through the onboarding GUI, one or more network slice workflows based on the configuring. The method further includes generating, through the onboarding GUI, a network slice bundle based on the one or more network slice workflows. The method further includes registering, through the onboarding GUI, the network slice bundle with the one or more registration databases for deployment of the network slice on the wireless network.

According to exemplary embodiments, an apparatus for onboarding a network slice associated with a wireless network includes at least one memory configured to store computer program code, and at least one processor configured to access said at least one memory and operate as instructed by said computer program code. The computer program code includes providing code configured to cause at least one of said at least one processor to provide an onboarding graphical user interface (GUI). The computer program code includes receiving code configured to cause at least one of said at least one processor to receive, from the onboarding GUI, a network slicing topology that specifies one or more network nodes of the wireless network. The computer program code further includes configuring code configured to cause at least one of said at least one processor to configure, through the onboarding GUI based on information retrieved from one or more registration databases, the network slicing topology. The computer program code further includes defining code configured to cause at least one of said at least one processor to define, through the onboarding GUI, one or more network slice workflows based on the configuring. The computer program code further includes generating code configured to cause at least one of said at least one processor to generate, through the onboarding GUI, a network slice bundle based on the one or more network slice workflows. The computer program code further includes registering code configured to cause at least one of said at least one processor to register, through the onboarding GUI, the network slice bundle with the one or more registration databases for deployment of the network slice on the wireless network.

According to exemplary embodiments, a non-transitory computer readable medium having instructions stored therein, which when executed by a processor cause the processor to execute a method for onboarding a network slice associated with a wireless network. The method includes providing an onboarding graphical user interface (GUI). The method further includes receiving, from the onboarding GUI, a network slicing topology that specifies one or more network nodes of the wireless network. The method further includes configuring, through the onboarding GUI based on information retrieved from one or more registration databases, the network slicing topology. The method further includes defining, through the onboarding GUI, one or more network slice workflows based on the configuring. The method further includes generating, through the onboarding GUI, a network slice bundle based on the one or more network slice workflows. The method further includes registering, through the onboarding GUI, the network slice bundle with the one or more registration databases for deployment of the network slice on the wireless network.

Additional embodiments will be set forth in the description that follows and, in part, will be apparent from the description, and/or may be learned by practice of the presented embodiments of the disclosure.

### BRIEF DESCRIPTION OF THE DRAWINGS

The above and other aspects, features, and aspects of embodiments of the disclosure will be apparent from the following description taken in conjunction with the accompanying drawings, in which:

FIG. 1 is a diagram of an example device for onboarding network slices in accordance with various embodiments of the present disclosure.

FIG. 2 is a schematic diagram of an example wireless communications system, in accordance with various embodiments of the present disclosure.

FIG. 3 is an example of multiple network slices implemented on a wireless communications system, in accordance with various embodiments of the present disclosure.

FIG. 4 is an example of a high-level network slice architecture for network slice management and configuration in a communications system, in accordance with various embodiments of the present disclosure.

FIG. 5 illustrates an example system process for onboarding network slices, in accordance with various embodiment of the present disclosure:

FIG. 6 illustrates an example graphical user interface (GUI) for onboarding a network slice, in accordance with various embodiments of the present disclosure.

FIG. 7 illustrates an example GUI for onboarding a network slice, in accordance with various embodiments of the present disclosure.

FIG. 8 illustrates example workflows with corresponding configurations, in accordance with various embodiments of the present disclosure.

FIG. 9 illustrates a sequence diagram of an example process of onboarding a network slice, in accordance with various embodiments of the present disclosure.

FIG. 10 illustrates a flow chart of an example process of onboarding a network slice, in accordance with various embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Network slicing may allow for network resources and network functions to be bundled into network slices depending on individual services, service level agreements (SLAs), and/or network path routing to be provided by each network slice. That is, a network slice over a communication network may provide customized network services by combining control plane (CP) and user plane (UP) network functions for network services necessary for a particular service over a core network (CN) and a radio access network (RAN) that may be interconnected to each other via a transport network (TN). A network function may be a virtualized network function that is used to realize a particular network capability.

However, related mechanisms for deploying and implementing network slicing functionality across network domains may rely on the use of different network slice subnet management function (NSSMF) devices for each domain (e.g., RN-NSSMF, CN-NSSMF, and TN-NSSMF). As such, configuring each domain (e.g., RAN, CN, and TN) to implement a network slice is a time consuming process. Furthermore, the configurations are specific to each network vendor and therefore, are generally not reusable for another network vendor. Aspects presented herein provide methods and apparatuses that provide a GUI for onboarding network slices. Further, aspects presented herein improve efficiency and performance of network slicing implementations by allowing set up of workflows for configuring multiple network domains.

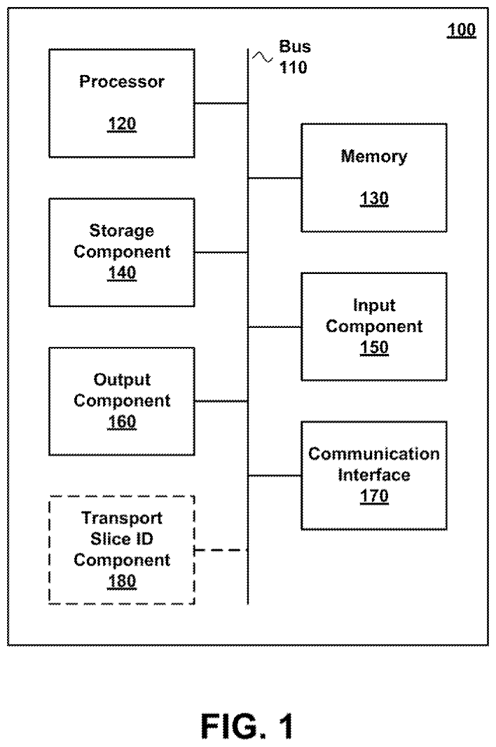

FIG. 1 is diagram of an example device for identifying transport network slices in a transport network. Device 100 may correspond to any type of known computer, server, or data processing device. For example, the device 100 may comprise a processor, a personal computer (PC), a printed circuit board (PCB) comprising a computing device, a mini-computer, a mainframe computer, a microcomputer, a telephonic computing device, a wired/wireless computing device (e.g., a smartphone, a personal digital assistant (PDA)), a laptop, a tablet, a smart device, or any other similar functioning device.

In some embodiments, as shown in FIG. 1, the device 100 may include a set of components, such as a processor 120, a memory 130, a storage component 140, an input component 150, an output component 160, a communication interface 170, and a transport slice identification (ID) component 180. The set of components of the device 100 may be communicatively coupled via a bus 110.

The bus 110 may comprise one or more components that permit communication among the set of components of the device 100. For example, the bus 110 may be a communication bus, a cross-over bar, a network, or the like. Although the bus 110 is depicted as a single line in FIG. 1, the bus 110 may be implemented using multiple (two or more) connections between the set of components of device 100. The disclosure is not limited in this regard.

The device 100 may comprise one or more processors, such as the processor 120. The processor 120 may be implemented in hardware, firmware, and/or a combination of hardware and software. For example, the processor 120 may comprise a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), a general purpose single-chip or multi-chip processor, or other programmable logic device, discrete gate or transistor logic, discrete hardware components, or any combination thereof designed to perform the functions described herein. A general purpose processor may be a microprocessor, or any conventional processor, controller, microcontroller, or state machine. The processor 120 also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function.

The processor 120 may control overall operation of the device 100 and/or of the set of components of device 100 (e.g., the memory 130, the storage component 140, the input component 150, the output component 160, the communication interface 170, the transport slice identification component 180).

The device 100 may further comprise the memory 130. In some embodiments, the memory 130 may comprise a random access memory (RAM), a read only memory (ROM), an electrically erasable programmable ROM (EEPROM), a flash memory, a magnetic memory, an optical memory, and/or another type of dynamic or static storage device. The memory 130 may store information and/or instructions for use (e.g., execution) by the processor 120.

The storage component 140 of device 100 may store information and/or computer-readable instructions and/or code related to the operation and use of the device 100. For example, the storage component 140 may include a hard disk (e.g., a magnetic disk, an optical disk, a magneto-optic disk, and/or a solid state disk), a compact disc (CD), a digital versatile disc (DVD), a universal serial bus (USB) flash drive, a Personal Computer Memory Card International Association (PCMCIA) card, a floppy disk, a cartridge, a magnetic tape, and/or another type of non-transitory computer-readable medium, along with a corresponding drive.

The device 100 may further comprise the input component 150. The input component 150 may include one or more components that permit the device 100 to receive information, such as via user input (e.g., a touch screen, a keyboard, a keypad, a mouse, a stylus, a button, a switch, a microphone, a camera, and the like). Alternatively or additionally, the input component 150 may include a sensor for sensing information (e.g., a global positioning system (GPS) component, an accelerometer, a gyroscope, an actuator, and the like).

The output component 160 of device 100 may include one or more components that may provide output information from the device 100 (e.g., a display, a liquid crystal display (LCD), light-emitting diodes (LEDs), organic light emitting diodes (OLEDs), a haptic feedback device, a speaker, and the like).

The device 100 may further comprise the communication interface 170. The communication interface 170 may include a receiver component, a transmitter component, and/or a transceiver component. The communication interface 170 may enable the device 100 to establish connections and/or transfer communications with other devices (e.g., a server, another device). The communications may be effected via a wired connection, a wireless connection, or a combination of wired and wireless connections. The communication interface 170 may permit the device 100 to receive information from another device and/or provide information to another device. In some embodiments, the communication interface 170 may provide for communications with another device via a network, such as a local area network (LAN), a wide area network (WAN), a metropolitan area network (MAN), a private network, an ad hoc network, an intranet, the Internet, a fiber optic-based network, a cellular network (e.g., a fifth generation (5G) network, a long-term evolution (LTE) network, a third generation (3G) network, a code division multiple access (CDMA) network, and the like), a public land mobile network (PLMN), a telephone network (e.g., the Public Switched Telephone Network (PSTN)), or the like, and/or a combination of these or other types of networks. Alternatively or additionally, the communication interface 170 may provide for communications with another device via a device-to-device (D2D) communication link, such as FlashLinQ, WiMedia, Bluetooth, ZigBee, Wi-Fi, LTE, 5G, and the like. In other embodiments, the communication interface 170 may include an Ethernet interface, an optical interface, a coaxial interface, an infrared interface, a radio frequency (RF) interface, or the like.

In some embodiments, the device 100 may comprise the transport slice identification component 180 configured to identify network slices in a transport network. For example, the transport slice identification component 180 may be configured to receive a slice creation request comprising a global identifier corresponding to a network slice, search a transport slice mapping database for at least one mapping entry corresponding to the global identifier, generate a transport slice identifier corresponding to the network slice, add a mapping entry to the transport slice mapping database, add another mapping entry to a transport slice path mapping database, and publish, to a performance monitoring system (PMS), the mapping entry and the another mapping entry.

The device 100 may perform one or more processes described herein. The device 100 may perform operations based on the processor 120 executing computer-readable instructions and/or code that may be stored by a non-transitory computer-readable medium, such as the memory 130 and/or the storage component 140. A computer-readable medium may refer to a non-transitory memory device. A memory device may include memory space within a single physical storage device and/or memory space spread across multiple physical storage devices.

Computer-readable instructions and/or code may be read into the memory 130 and/or the storage component 140 from another computer-readable medium or from another device via the communication interface 170. The computer-readable instructions and/or code stored in the memory 130 and/or storage component 140, if or when executed by the processor 120, may cause the device 100 to perform one or more processes described herein.

Alternatively or additionally, hardwired circuitry may be used in place of or in combination with software instructions to perform one or more processes described herein. Thus, embodiments described herein are not limited to any specific combination of hardware circuitry and software.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally or alternatively, a set of (one or more) components shown in FIG. 1 may perform one or more functions described as being performed by another set of components shown in FIG. 1.

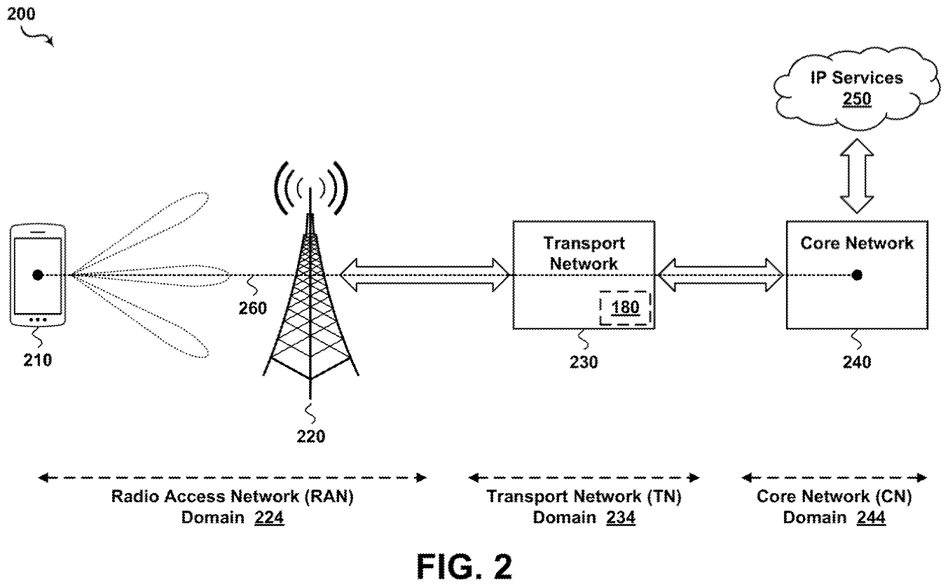

FIG. 2 is a diagram illustrating an example of a wireless communications system, according to various embodiments of the present disclosure. The wireless communications system 200 (which may also be referred to as a wireless wide area network (WWAN)) may include one or more user equipment (UE) 210, one or more base stations 220, at least one transport network 230, and at least one core network 240.

The one or more UEs 210 may access the at least one core network 240 and/or IP services 250 via a connection to the one or more base stations 220 over a RAN domain 224 and through the at least one transport network 230. Examples of UEs 210 may include a cellular phone, a smart phone, a session initiation protocol (SIP) phone, a laptop, a personal digital assistant (PDA), a satellite radio, a global positioning system (GPS), a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similarly functioning device. Some of the one or more UEs 210 may be referred to as Internet-of-Things (IOT) devices (e.g., parking meter, gas pump, toaster, vehicles, heart monitor, etc.). The one or more UEs 210 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile agent, a client, or some other suitable terminology.

The one or more base stations 220 may wirelessly communicate with the one or more UEs 210 over the RAN domain 224. Each base station of the one or more base stations 220 may provide communication coverage to one or more UEs 210 located within a geographic coverage area of that base station 220. In some embodiments, as shown in FIG. 2, the base station 220 may transmit one or more beamformed signals to the one or more UEs 210 in one or more transmit directions. The one or more UEs 210 may receive the beamformed signals from the base station 220 in one or more receive directions. Alternatively or additionally, the one or more UEs 210 may transmit beamformed signals to the base station 220 in one or more transmit directions. The base station 220 may receive the beamformed signals from the one or more UEs 210 in one or more receive directions.

The one or more base stations 220 may include macrocells (e.g., high power cellular base stations) and/or small cells (e.g., low power cellular base stations). The small cells may include femtocells, picocells, and microcells. A base station 220, whether a macrocell or a large cell, may include and/or be referred to as an access point (AP), an evolved (or evolved universal terrestrial radio access network (E-UTRAN)) Node B (eNB), a next-generation Node B (gNB), or any other type of base station known to one of ordinary skill in the art.

The one or more base stations 220 may be configured to interface (e.g., establish connections, transfer data, and the like) with the at least one core network 240 through at least one transport network 230. In addition to other functions, the one or more base stations 220 may perform one or more of the following functions: transfer of data received from the one or more UEs 210 (e.g., uplink data) to the at least one core network 240 via the at least one transport network 230, transfer of data received from the at least one core network 240 (e.g., downlink data) via the at least one transport network 230 to the one or more UEs 210.

The transport network 230 may transfer data (e.g., uplink data, downlink data) and/or signaling between the RAN domain 224 and the CN domain 244. For example, the transport network 230 may provide one or more backhaul links between the one or more base stations 220 and the at least one core network 240. The backhaul links may be wired or wireless. Alternatively or additionally, the transport network 230 may comprise the transport slice identification component 180 of FIG. 1.

The core network 240 may be configured to provide one or more services (e.g., enhanced mobile broadband (eMBB), ultra-reliable low-latency communications (URLLC), and massive machine type communications (mMTC), etc.) to the one or more UEs 210 connected to the RAN domain 224 via the TN domain 234. Alternatively or additionally, the core network 240 may serve as an entry point for the IP services 250. The IP services 250 may include the Internet, an intranet, an IP multimedia subsystem (IMS), a streaming service (e.g., video, audio, gaming, etc.), and/or other IP services.

Continuing to refer to FIG. 2, an end-to-end network slice 260 may provide a required connectivity between the UE 210 and the core network 240 with a specified performance commitment. The end-to-end network slice 260 may refer to a logical network topology connecting a number of endpoints (e.g., UE 210, core network 240) using a set of shared or dedicated network resources (e.g., base station 220, transport network 230) that are used to satisfy a specific performance commitment. The performance commitments that are to be satisfied by the end-to-end network slice 260 may be referred to as service level agreements (SLAs), service level objectives (SLOs), service level expectations (SLEs), and/or service level indicators (SLIs). Examples of these performance commitments may include, but are not limited to, a guaranteed minimum bandwidth (e.g., bandwidth between two end points in a particular direction), a guaranteed maximum latency (e.g., network latency when transmitting between two endpoints), a maximum permissible delay variation (PDV) (e.g., a maximum difference in a one-way delay between sequentially transmitted packets in a flow), a maximum permissible packet loss rate (e.g., a ratio of packets dropped to packets transmitted), and a minimum availability ratio (e.g., a ratio of uptime to the sum of uptime and downtime).

The UE 210 may access multiple network slices 260 over one or more base stations 220 (not shown). In some embodiments, each network slice 260 may serve a particular service type with a specified performance commitment.

In some embodiments, each network slice 260 may be identified by a global identifier, such as a single network slice selection assistance information (S-NSSAI). That is, the S-NSSAI may be used by the RAN domain 224, the TN domain 234, and the CN domain 244 to identify the network slice 260.

The S-NSSAI may comprise information regarding a slice and/or service type (SST), which may indicate an expected behavior of the particular network slice in terms of features and/or services. The S-NSSAI may further comprise a slice differentiator (SD), which may allow for further differentiation for selecting a network slice instance from one or more network slice instances that may comply with the indicated SST. Alternatively or additionally, the SST and/or the SD comprised by the S-NSSAI may use standard values and/or may use values specific to a particular network provider (e.g., public land mobile network (PLMN)).

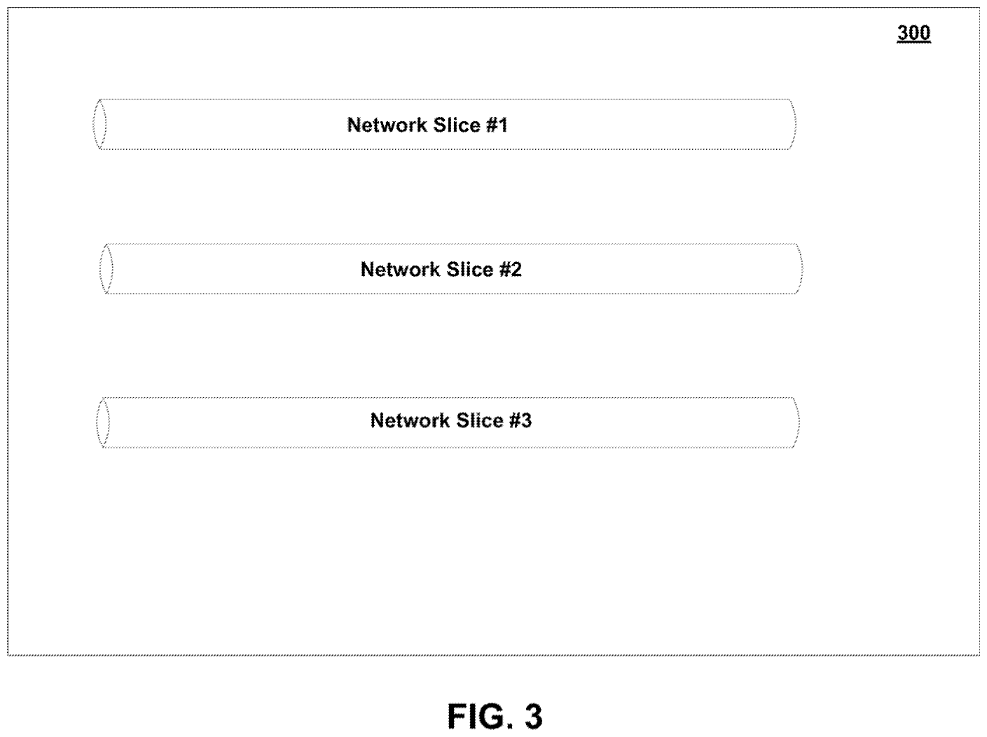

FIG. 3 illustrates an example of implementing multiple network slices on a wireless communications system 300. The wireless communications system 300 may correspond to system 200 (FIG. 2). Each network slice #1-#3 may correspond to a separate network slice 260 (FIG. 2). As illustrated in FIG. 3, multiple network slices may be implemented simultaneously on the wireless communications system 300. Each network slice #1-#3 may correspond to a different service. For example, network slice #1 may correspond to a network service provided by an energy company for connectivity of IoT devices (e.g., gas meters, sensors, etc.). Network slice #2 may correspond to a network service provided by a content provider for providing a stream service to UEs 210 (FIG. 2). Network slice #3 may correspond to a network service for providing Voice over IP (VOIP) to UEs 210. Although only three network slices are illustrated in FIG. 3, any desired number of network slices may be implemented as permitted by the resources of the wireless communications system 300.

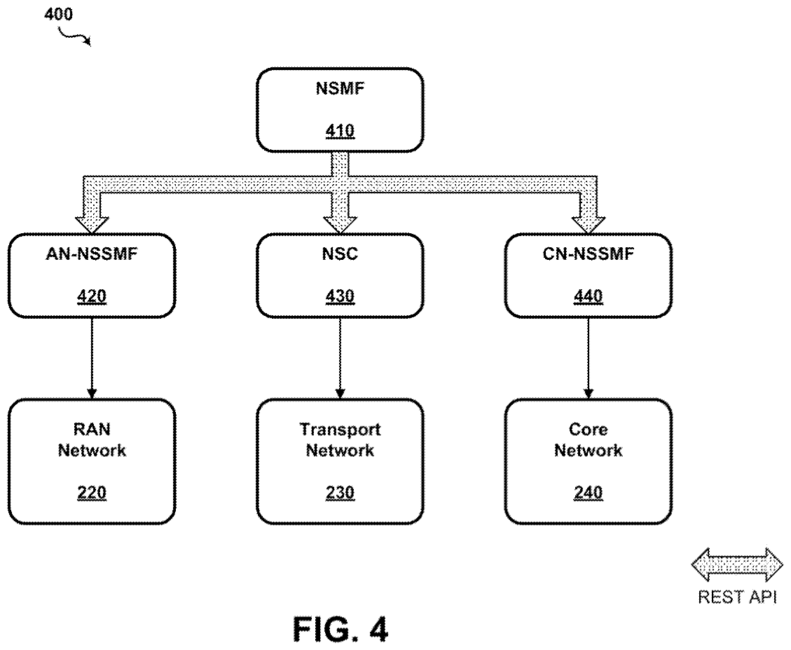

FIG. 4 is an example of a high-level network slice architecture for network slice management and configuration in a communications system, in accordance with various embodiments of the present disclosure. The high-level network slice architecture 400 described in FIG. 4 may be implemented by and/or be included with the wireless communications system 200 described above with reference to FIG. 2, and may include additional features not mentioned above. In some embodiments, at least a portion of the high-level network slice architecture 400 illustrated in FIG. 4 may be performed by the device 100 of FIG. 1, including the transport slice identification component 180.

As shown in FIG. 4, a network slice management function (NSMF) 410 may request each domain (e.g., RAN, TN, CN) of the network architecture to create a portion (e.g., subnet) of the network slice 260 in each network domain. That is, the network slice 260 may be implemented by a combination of subnets created within each domain of the network to establish the communication path across the communications system. The NSMF 410 may be configured to generate a S-NSSAI that uniquely identifies the network slice 260. Alternatively or additionally, the NSMF 410 may create one or more service profiles requesting dedicated resources for the network slice 260 in each network domain. The service profiles may be determined according to one or more services to be provided over the network slice 260 and/or the specified performance commitments of the network slice 260.

In some embodiments, the NSMF 410 may use a representational state transfer application programming interface (REST-API) to request each of the domains to create their respective portions of the network slice 260. Alternatively or additionally, the NSMF 410 may transmit and/or send a message comprising the slice creation request to a network element corresponding to each of the network domains. The present disclosure is not limited in this regard.

In some embodiments, the NSMF 410 may send a slice creation request to an access network-network slice subnet management function (AN-NSSMF) 420, such as a RAN path computation element and/or a RAN orchestrator, to create the RAN domain portion of the network slice 260. For example, the slice creation request sent by the NSMF 410 to the AN-NSSMF 420 may comprise the S-NSSAI identifying the network slice 260 and/or the service profile determined for the RAN domain 224.

In response to receiving the slice creation request from the NSMF 410, the AN-NSSMF 420 may allocate one or more resources (e.g., time periods, frequency ranges, bandwidths) of the RAN domain 224 for the network slice 260. That is, the AN-NSSMF 420 may configure one or more base stations 220 of the RAN domain 224 and/or other network elements of the RAN domain 224 to provide a network path between the UE 210 and the transport network 230 according to the performance commitments specified for the network slice 260. Alternatively or additionally, the AN-NSSMF 420 may further allocate the RAN resources according to other performance factors such as, but not limited to, available processing throughput of allocated devices, latency considerations, geographical location of allocated devices, priority of services associated with the network slice 260, and the like.

In some embodiments, the NSMF 410 may send a slice creation request to a transport network-network slice subnet management function (TN-NSSMF) 430, such as a network slice controller (NSC) and/or a TN orchestrator, to create the TN domain portion of the network slice 260. For example, the slice creation request sent by the NSMF 410 to the NSC 430 may comprise the S-NSSAI identifying the network slice 260 and/or the service profile determined for the TN domain 234.

In other embodiments, the NSC 430 may comprise the transport slice identification component 180. In such embodiments, the NSC 430 may be further configured to generate a transport slice identifier corresponding to the network slice 260 based at least on the S-NSSAI indicated by the slice creation request received from the NSMF 410.

In response to receiving the slice creation request from the NSMF 410, the NSC 430 may compute and/or allocate one or more transport network paths for the network slice 260. For example, the NSC 430 may select transport network paths based at least on a source address indicated by the slice creation request, a destination address indicated by the slice creation request, and/or network path constraints (e.g., service profile, performance commitments) indicated by the slice creation request. Alternatively or additionally, the NSC 430 may configure one or more network elements of the TN network 230 to provide the one or more transport network paths between the RAN domain 224 and the core network 240 according to the performance commitments specified for the network slice 260.

In some embodiments, the NSMF 410 may send a slice creation request to a core network-network slice subnet management function (CN-NSSMF) 440, such as a CN path computation element and/or a CN orchestrator, to create the CN domain portion of the network slice 260. For example, the slice creation request sent by the NSMF 410 to the CN-NSSMF 440 may comprise the S-NSSAI identifying the network slice 260 and/or the service profile determined for the CN domain 244.

In response to receiving the slice creation request from the NSMF 410, the CN-NSSMF 440 may compute and/or allocate one or more core network paths for the network slice 260 to provide a network path between the UE 210 and one or more services indicated by the slice creation request. For example, the CN-NSSMF 440 may select core network paths based at least on a source address indicated by the slice creation request, a destination address indicated by the slice creation request, and/or network path constraints (e.g., service profile, performance commitments) indicated by the slice creation request. Alternatively or additionally, the CN-NSSMF 440 may configure one or more network elements of the CN network 240 to provide the one or more services indicated by the slice creation request to the UE 210, according to the performance commitments specified for the network slice 260.

As described above in reference to FIG. 4, each domain (e.g., RAN, TN, CN) of the network architecture may comprise an independent network slicing management function (e.g., AN-NSSMF 420, NSC 430, CN-NSSMF 440). These management functions may manage their respective portions of the network slice 260 without coordination and/or cooperation among them. As a result, each network domain (e.g., RAN, TN, CN) may require a different configuration for implementing a network slice. These configuration may or may not be known when designing the slice, and could be generated at the time of deployment.

According to some embodiments, a transport slice identification component 180 that may be configured to generate a transport slice identifier corresponding to the network slice 260 based at least on the S-NSSAI. The transport slice identification component 180 may be further configured to publish a mapping of the transport slice identifier to the network slice 260 and to the transport network path allocated to the network slice 260. As a result, a performance monitoring system may perform end-to-end monitoring of network slice performance, as well as, visualizations of the transport network paths. Thus, allowing for fault detection and isolation at an individual network slice and/or transport flow level.

The number and arrangement of components shown in FIG. 4 are provided as an example. In practice, there may be additional components, fewer components, different components, or differently arranged components than those shown in FIG. 4. Furthermore, two or more components shown in FIG. 4 may be implemented within a single component, or a single component shown in FIG. 4 may be implemented as multiple, distributed components. Additionally or alternatively, a set of (one or more) components shown in FIG. 4 may perform one or more functions described as being performed by another set of components shown in FIGS. 1-4.

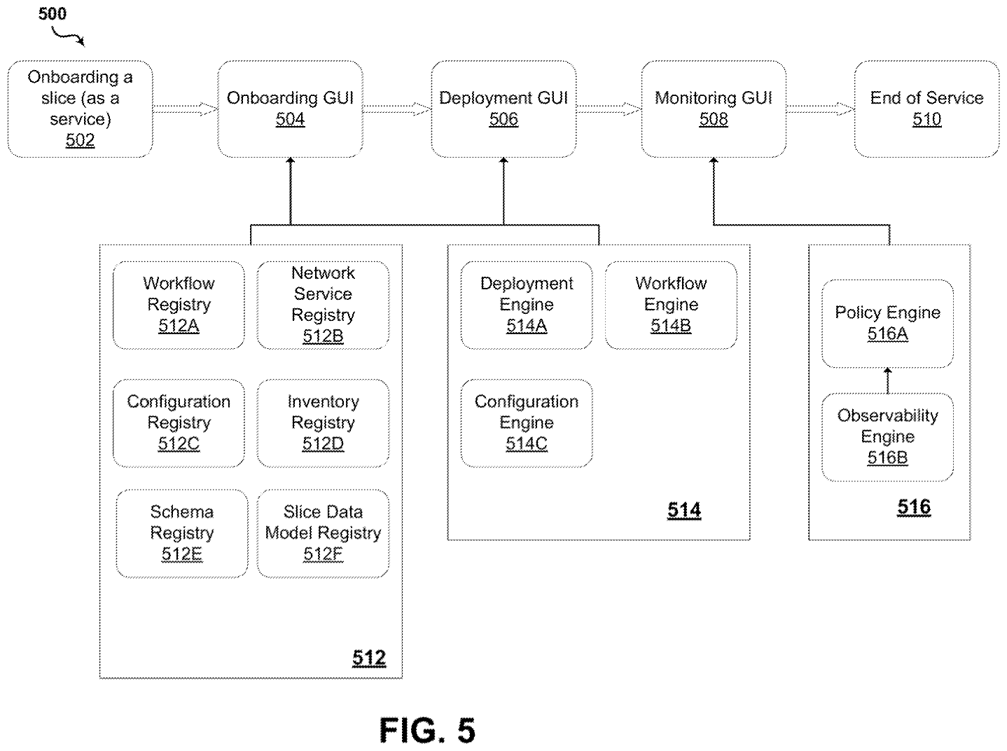

FIG. 5 illustrates an example system process 500 for onboarding a network slice. The onboarding process may be provided as a service 502 to a network vendor. For example, the network vendor may access an onboarding GUI 504 to set up a network slice such as network slice 260 (FIG. 2). In some embodiments, the onboarding GUI 504 enables a network vendor to design a network slice and output a network slice bundle for deployment of the network slice on a wireless communications system such as system 200 (FIG. 2). According to some embodiments, a registration repository 512 is accessible to the onboarding GUI 504. The onboarding GUI 504 may retrieve information from the registration repository 512 and store information in the registration repository 512. The registration repository 512 may be composed of one or more databases.

In some embodiments, the registration repository 512 may include a workflow registry 512A, a network service registry 512B, a configuration registry 512C, an inventory registry 512D, a schema registry 512E, and a slice data model registry 512F. The workflow registry 512A may store predefined workflows for each network domain. The network service registry 512B may include a catalog of registered and available network services. The configuration registry 512C may include configurations and/or parameters for each network service. The inventory registry 512D may include information of schema of all available network services/managed functions that are available for network slicing. The schema registry 512E may contain slice related information elements such as a service profile, slice profile, QoS profile, each of which may be updated as necessary. The slice data model registry 512F may store and register created network slices as well as any other available slices.

In some embodiments, after the network slice is designed and prepared as a bundle, a deployment GUI 506 may be provided. A deployment repository 514 may be accessible to the deployment GUI 506. The deployment GUI 506 may retrieve information from the deployment repository 514 and store information in the deployment repository 514. The deployment repository 514 may be composed of one or more databases.

In some embodiments, the deployment repository 514 may include a deployment engine 514A, a workflow engine 514B, and a configuration engine 514C. The deployment engine 514A may include one or more modules for implementing a network slice based on a network slice bundle registered with the registration repository 512. The workflow engine 514B may include one or more modules for implementing one or more workflows included in the network slice bundle registered with the registration repository 512. The configuration engine 514C may include one or more modules for implementing one or more configurations or parameters included in the workflows implemented by the workflow engine 514B.

In some embodiments, after the network slice is deployed, a monitoring GUI 508 may be provided for monitoring the network slice. A monitoring repository 516 may be accessible to the monitoring GUI 508. The monitoring GUI 508 may retrieve information from the monitoring repository 516 and store information in the monitoring repository 516. The monitoring repository 516 may be composed of one or more databases.

In some embodiments, the monitoring repository includes a policy engine 516A and an observability engine 516B. The policy engine 516A may include or more rules (e.g., policies) regarding the implementation and execution of the network slice. For example, the policies may define the action to be taken in case there is a breach in a service level agreement guaranteed by the slices. The observability engine 516B may include one or more modules for tracking the performance of the network slice. The system process 500 may end when an end of service 510 is reached (e.g., network slice has reached end of life cycle indicating the corresponding network service is no longer available).

The number and arrangement of components shown in FIG. 5 are provided as an example. In practice, there may be additional components, fewer components, different components, or differently arranged components than those shown in FIG. 5. Furthermore, two or more components shown in FIG. 5 may be implemented within a single component, or a single component shown in FIG. 5 may be implemented as multiple, distributed components. Additionally or alternatively, a set of (one or more) components shown in FIG. 5 may perform one or more functions described as being performed by another set of components shown in FIGS. 1-5.

It may be understood that the specific order of the operations, the quantity of operations, and arrangement of operations in the system process 500 described in FIG. 5 is an illustration of one example approach. Based upon design preferences, it may be understood that the specific order, quantity, and/or arrangement of operations in the system process 500 may be rearranged. Further, some operations may be added, combined, or omitted.

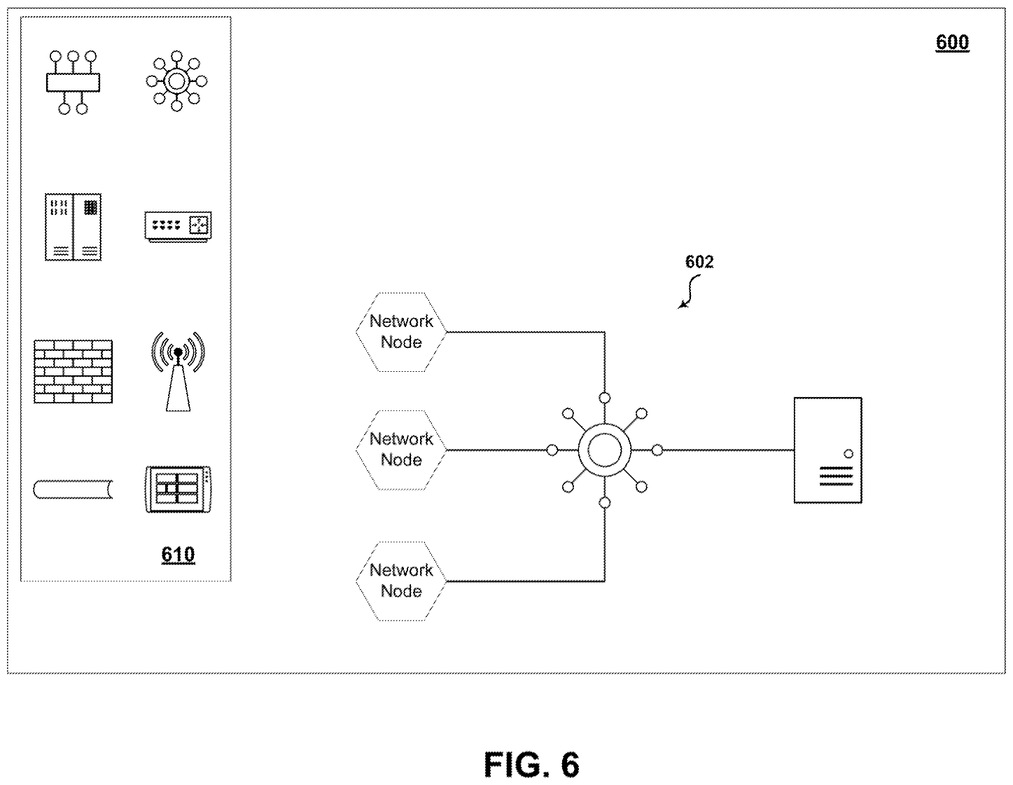

FIG. 6 illustrates an example of an onboarding GUI. In some embodiments, the onboarding GUI may include a network topology design window 600 for designing a network topology 602. The network topology 602 may be created by dragging and dropping symbols from a symbol library 610. The network topology 602 may include one or more devices and nodes corresponding to the wireless communications system 200 (FIG. 2). Therefore the network topology 602 may include nodes corresponding to the RAN domain 224, TN domain 234, and CN domain 244.

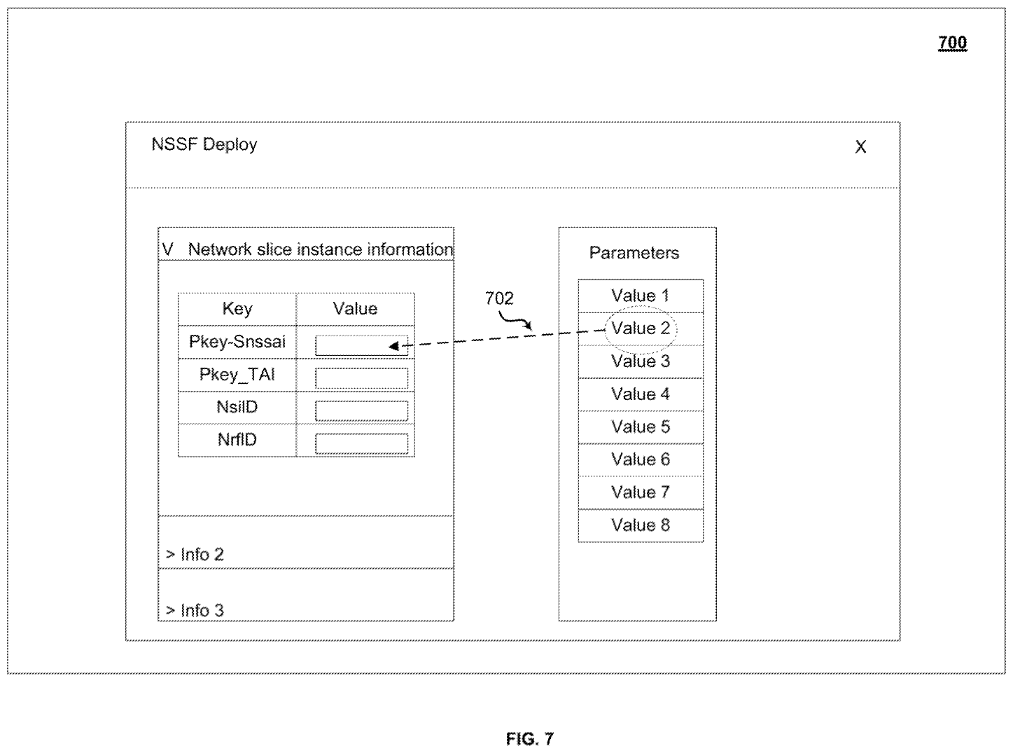

In some embodiments, the onboarding GUI includes a user interface for configuring the network topology 602 (FIG. 6). FIG. 7 illustrates an example user interface 700 for configuring a network topology. For example, upon selecting a node in the network topology 602, the onboarding GUI may retrieve available services for the node from the network service registry 512B, and available configurations/parameters for the services from the configuration registry 512C. As illustrated in FIG. 7 corresponding values of a parameter may be retrieved and displayed in the interface 700, where a particular value (e.g., Value 2) may be dragged and dropped 702 to set a value of a particular parameter (e.g., Pkey-Snssai). Nodes from any one of the RAN domain 224, TN domain 234, and CN domain 244 may be configured in user interface 700.

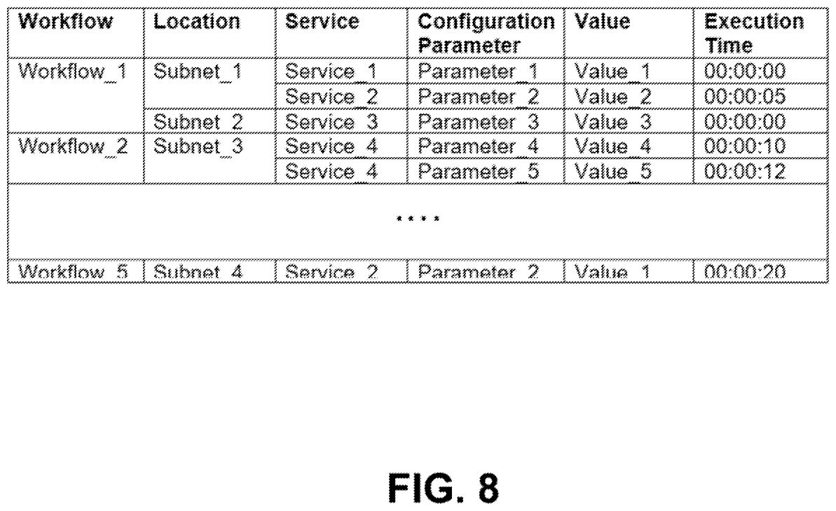

FIG. 8 illustrates an example list of workflows included in a network slice bundle. As an example, a workflow may specify a particular location (e.g., subnet), service, configuration parameter, value, and execution time. The location may correspond to a subnet in any one of the RAN domain 224, TN domain 234, and CN domain 244. As illustrated in FIG. 8, Workflow_1 includes Subnet_1 that utilizes Service_1 and Service_2. Service_1 may have Paremeter_1 set to Value_1 at time 00:00:00. Service_2 may have Parameter_2 set to Value 2 at time 00:00:05. As illustrated in FIG. 8, a service may use different parameters set to different values at different times (e.g., Service_4 for Workflow_2).

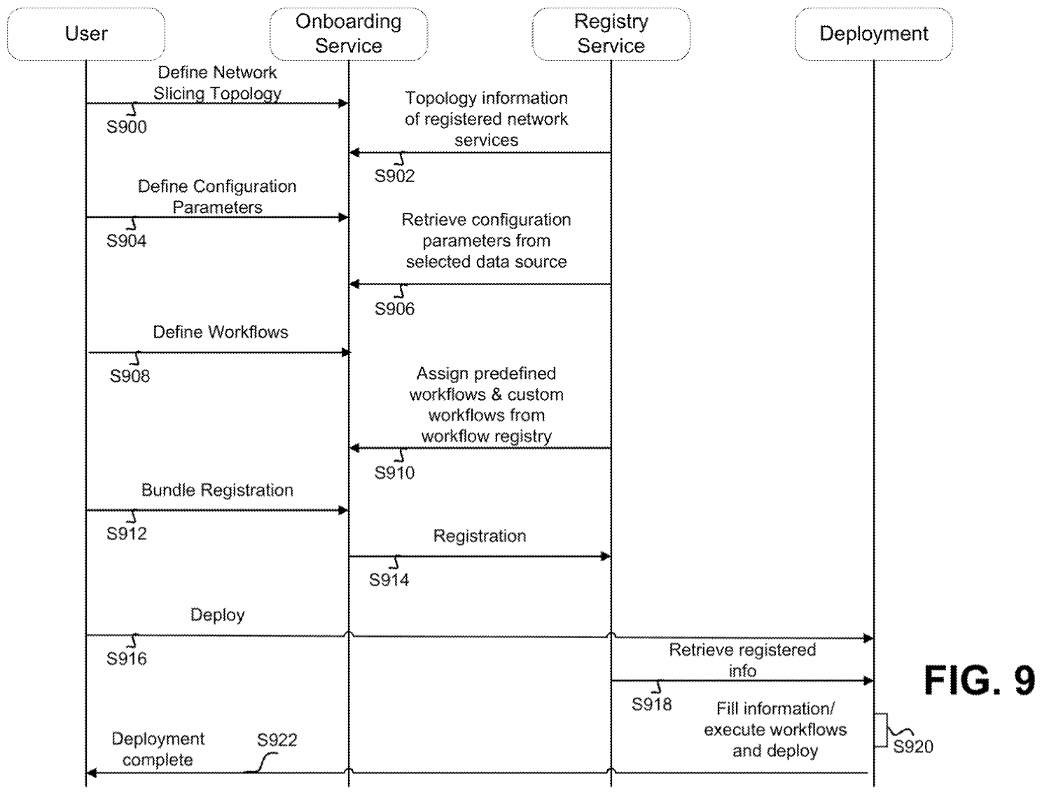

FIG. 9 illustrates an example sequence diagram for implementing an embodiment of onboarding a network slice. The process may start at step S900 where a network slice topology is defined. For example, a network vendor may access interface 600 (FIG. 6) of an onboarding GUI to define the network slice topology 602. The process may proceed to step S902 where the registry service provides topology information of registered network services. For example, a list of available network services for the network slice topology 602 may be retrieved from the network service registry 512B of registration repository 512. After the list of available network services are retrieved and displayed in the onboarding GUI, the network vendor may make a selection of one or more services to configure a node.

The process may proceed to step S904 where configuration parameters are defined. The configuration parameters may be defined for a selected network service. For example, the configuration needed for a slice may be determined by a vendor (A) when onboarding the network service. The formula value of A=B+C to derive the value of the parameter may be derived from multiple other parameters that are already existing in the system or from other systems. These features make it possible to interface with a vendor management services easily. The parameter A may be available in the system as a value of a parameter to be configured. Parameters B and C may be available in one of the registries that may include the configuration registry, catalog registry, or inventory schema of a slice profile and a service profile. This entire set of configuration formulae may be encapsulated as a translation matrix which is calculated at different points in time. The process may proceed to step S906 where configuration parameters from a selected data source may be retrieved. For example, configuration parameters may be retrieved from the configuration registry 512C of registration repository 512.

The process may proceed to step S908 where workflows are defined. For example, the workflows may be defined in accordance with the workflows illustrated in FIG. 8. The process proceeds to step S910 where predefined workflow and custom workflows from the workflow registry are assigned. For example, predefined workflows and/or custom workflows may be retrieved from workflow registry 512A and assigned. As an example, a predefined workflow and/or custom workflow may specify that one or more parameters will have specified corresponding values at a predetermined time. The workflows may also be interconnected such that the output of workflow A is used as an input to Workflow B to determine the value of parameter/configuration based on a defined translation matrix and based on multiple data sources. For example, one parameter may be known during design, while another parameter may be known during deployment, and a value of parameter C may be a combination of the other two parameters.

The process may proceed to step S912 where the network vendor may request bundle registration of the network slice through the onboarding GUI. The process may subsequently proceed to step S914 where the network slice bundle is registered with the registration repository 512. The process may subsequently proceed to step S916 where the network slice is deployed.

The process may proceed to step S918 where the network slice bundle registration is retrieved from registration repository 512. The process may subsequently proceed to step S920 where the workflows in the network slice bundle registration are executed to deploy the network slice. Upon completion of the execution of the workflows, the process may proceed to step S922 for deployment completion. As an example, upon completion of deployment, the network vendor may receive a message through the onboarding GUI.

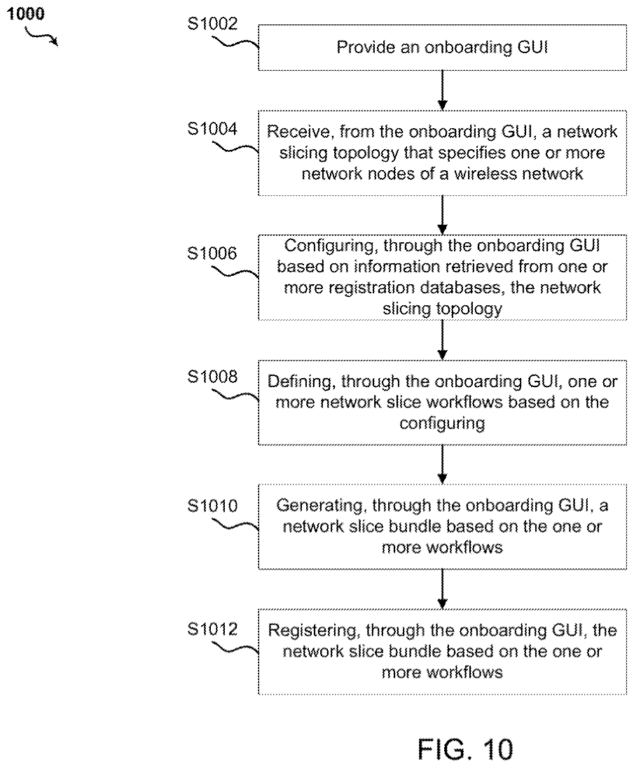

FIG. 10 illustrates a flowchart of an example process 1000 for onboarding a network slice. The process illustrated in FIG. 10 may be performed by device 100 (FIG. 1). The process may generally start at step S1002 where an onboarding GUI is provided. The process may proceed to step S1004 where a network slicing topology that specifies one or more network nodes of a wireless network is received from the onboarding GUI. As an example, the network slicing topology 602 may be specified in the interface 600 (FIG. 6) of the onboarding GUI.

The process may proceed to step S1006 where the network slicing topology is configured through the onboarding GUI based on information retrieved from one or more registration databases. For example, the network slicing topology specified in FIG. 6 may be configured as illustrated in FIG. 7. The process may proceed to step S1008 where one or more network slice workflows are defined through the onboarding GUI based on the configuring performed in the prior step.

The process may proceed to step S1010 where a network slice bundle is generated through the onboarding GUI based on the one or more workflows defined in the previous step. The network slice bundle may include the workflows illustrated in FIG. 8. The process may proceed to step S1012 where the network slice bundle is registered through the onboarding GUI. For example, the network slice bundle may be registered with the registration repository 512.

The foregoing disclosure provides illustration and description, but is not intended to be exhaustive or to limit the implementations to the precise form disclosed. Modifications and variations are possible in light of the above disclosure or may be acquired from practice of the implementations.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

The above disclosure also encompasses the embodiments listed below:
(1) A method for onboarding a network slice associated with a wireless network, the method including: providing an onboarding graphical user interface (GUI); receiving, from the onboarding GUI, a network slicing topology that specifies one or more network nodes of the wireless network: configuring, through the onboarding GUI based on information retrieved from one or more registration databases, the network slicing topology: defining, through the onboarding GUI, one or more network slice workflows based on the configuring: generating, through the onboarding GUI, a network slice bundle based on the one or more network slice workflows; and registering, through the onboarding GUI, the network slice bundle with the one or more registration databases for deployment of the network slice on the wireless network.
(2) The method according to feature (1), in which the one or more registration databases includes a network service registry, and in which the configuring the network slicing technology further includes: retrieving, from the network service registry, one or more network services for the network slicing topology: and receiving, from the onboarding GUI for the one or more network nodes in the network slicing topology, a selection of one or more network services from the retrieved one or more network services.
(3) The method according to feature (2), in which the one or more registration databases includes a configuration parameters registry, and in which the configuring the network slicing technology further includes retrieving, from the configuration parameters registry, one or more configuration parameters for the selected one or more network services; and receiving, from the onboarding GUI, a selection of one or more configuration parameters from the retrieved one or more configuration parameters.
(4) The method of feature (3), in which the defining the one or more network slice workflows further comprises specifying a timing of utilizing the selected one or more configuration parameters for a corresponding selected network service.
(5) The method according to any one of features (1)-(4), in which the one or more databases include a workflow registry, and in which the defining the one or more network slice workflows further includes: retrieving, from the workflow registry, one or more predefined workflows: and assigning at least one of the one or more predefined workflows to the one or more network slice workflows.
(6) The method according to any one of features (1)-(5), in which the network slice bundle is registered with the one or more databases, and the network slice is deployed via execution of the one or more network flows specified in the network slice bundle.
(7) The method according to any one of features (1)-(6), in which the network slicing topology includes one or more of a radio access network (RAN) domain, transport domain, and a core network domain.
(8) An apparatus for onboarding a network slice associated with a wireless network, the apparatus including: at least one memory configured to store computer program code; and at least one processor configured to access said at least one memory and operate as instructed by said computer program code, said computer program code including: providing code configured to cause at least one of said at least one processor to provide an onboarding graphical user interface (GUI): receiving code configured to cause at least one of said at least one processor to receive, from the onboarding GUI, a network slicing topology that specifies one or more network nodes of the wireless network: configuring code configured to cause at least one of said at least one processor to configure, through the onboarding GUI based on information retrieved from one or more registration databases, the network slicing topology; defining code configured to cause at least one of said at least one processor to define, through the onboarding GUI, one or more network slice workflows based on the configuring; generating code configured to cause at least one of said at least one processor to generate, through the onboarding GUI, a network slice bundle based on the one or more network slice workflows; and registering code configured to cause at least one of said at least one processor to register, through the onboarding GUI, the network slice bundle with the one or more registration databases for deployment of the network slice on the wireless network.
(9) The apparatus according to feature (8), in which the one or more registration databases includes a network service registry, and in which the configuring code further includes: retrieving code configured to cause at least one of said at least one processor to retrieve, from the network service registry, one or more network services for the network slicing topology: and receiving code configured to cause at least one of said at least one processor to receive, from the onboarding GUI for the one or more network nodes in the network slicing topology, a selection of one or more network services from the retrieved one or more network services.
(10) The apparatus according to feature (9), in which the one or more registration databases includes a configuration parameters registry, and in which the configuring code further comprises: retrieving code configured to cause at least one of said at least one processor to retrieve, from the configuration parameters registry, one or more configuration parameters for the selected one or more network services; and receiving code configured to cause at least one of said at least one processor to receive, from the onboarding GUI, a selection of one or more configuration parameters from the retrieved one or more configuration parameters.
(11) The apparatus according to feature (10), in which the defining further includes specifying code configured to cause at least one of said at least one processor to specify a timing of utilizing the selected one or more configuration parameters for a corresponding selected network service.
(12) The apparatus according to any one of features (8)-(11), in which the one or more databases include a workflow registry, and in which the defining code further includes: retrieving code configured to cause at least one of said at least one processor to retrieve, from the workflow registry, one or more predefined workflows: and assigning code configured to cause at least one of said at least one processor to assign at least one of the one or more predefined workflows to the one or more network slice workflows.
(13) The apparatus according to any one of features (8)-(12), in which the network slice bundle is registered with the one or more databases, and the network slice is deployed via execution of the one or more network flows specified in the network slice bundle.
(14) The apparatus according to any one of features (8)-(13), in which the network slicing topology includes one or more of a radio access network (RAN) domain, transport domain, and a core network domain.
(15) A non-transitory computer readable medium having instructions stored therein, which when executed by a processor cause the processor to execute a method for onboarding a network slice associated with a wireless network, the method includes: providing an onboarding graphical user interface (GUI); receiving, from the onboarding GUI, a network slicing topology that specifies one or more network nodes of the wireless network: configuring, through the onboarding GUI based on information retrieved from one or more registration databases, the network slicing topology: defining, through the onboarding GUI, one or more network slice workflows based on the configuring: generating, through the onboarding GUI, a network slice bundle based on the one or more network slice workflows; and registering, through the onboarding GUI, the network slice bundle with the one or more registration databases for deployment of the network slice on the wireless network.
(16) The non-transitory computer readable medium according to feature (15), in which the one or more registration databases includes a network service registry, and in which the configuring the network slicing technology further includes: retrieving, from the network service registry, one or more network services for the network slicing topology: and receiving, from the onboarding GUI for the one or more network nodes in the network slicing topology, a selection of one or more network services from the retrieved one or more network services.
(17) The non-transitory computer readable medium according to feature (16), in which the one or more registration databases includes a configuration parameters registry, and in which the configuring the network slicing technology further includes: retrieving, from the configuration parameters registry, one or more configuration parameters for the selected one or more network services: and receiving, from the onboarding GUI, a selection of one or more configuration parameters from the retrieved one or more configuration parameters.
(18) The non-transitory computer readable medium according to feature (17), in which the defining the one or more network slice workflows further includes specifying a timing of utilizing the selected one or more configuration parameters for a corresponding selected network service.
(19) The non-transitory computer readable medium according to any one of features (15)-(18), in which the one or more databases include a workflow registry, and in which the defining the one or more network slice workflows further includes: retrieving, from the workflow registry, one or more predefined workflows; and assigning at least one of the one or more predefined workflows to the one or more network slice workflows.
(20) The non-transitory computer readable medium according to any one of features (15)-(19), in which the network slice bundle is registered with the one or more databases, and the network slice is deployed via execution of the one or more network flows specified in the network slice bundle.

What is claimed is:

1. A method for onboarding a network slice associated with a wireless network, the method comprising:
providing an onboarding graphical user interface (GUI);
receiving, from the onboarding GUI, a network slicing topology that specifies one or more network nodes of the wireless network;
configuring, through the onboarding GUI based on information retrieved from one or more registration databases, the network slicing topology;
defining, through the onboarding GUI, one or more network slice workflows based on the configuring;
generating, through the onboarding GUI, a network slice bundle based on the one or more network slice workflows; and
registering, through the onboarding GUI, the network slice bundle with the one or more registration databases for deployment of the network slice on the wireless network.

2. The method according to claim 1, wherein the one or more registration databases includes a network service registry, and wherein the configuring the network slicing technology further comprises:
retrieving, from the network service registry, one or more network services for the network slicing topology; and
receiving, from the onboarding GUI for the one or more network nodes in the network slicing topology, a selection of one or more network services from the retrieved one or more network services.

3. The method according to claim 2, wherein the one or more registration databases includes a configuration parameters registry, and wherein the configuring the network slicing technology further comprises:
retrieving, from the configuration parameters registry, one or more configuration parameters for the selected one or more network services; and
receiving, from the onboarding GUI, a selection of one or more configuration parameters from the retrieved one or more configuration parameters.

4. The method of claim 3, wherein the defining the one or more network slice workflows further comprises specifying a timing of utilizing the selected one or more configuration parameters for a corresponding selected network service.

5. The method of claim 1, wherein the one or more databases include a workflow registry, and wherein the defining the one or more network slice workflows further comprises:
retrieving, from the workflow registry, one or more predefined workflows; and
assigning at least one of the one or more predefined workflows to the one or more network slice workflows.

6. The method of claim 1, wherein the network slice bundle is registered with the one or more databases, and the network slice is deployed via execution of the one or more network flows specified in the network slice bundle.

7. The method of claim 1, wherein the network slicing topology includes one or more of a radio access network (RAN) domain, transport domain, and a core network domain.

8. An apparatus for onboarding a network slice associated with a wireless network, the apparatus comprising:
at least one memory configured to store computer program code; and
at least one processor configured to access said at least one memory and operate as instructed by said computer program code, said computer program code including:
providing code configured to cause at least one of said at least one processor to provide an onboarding graphical user interface (GUI);
receiving code configured to cause at least one of said at least one processor to receive, from the onboarding GUI, a network slicing topology that specifies one or more network nodes of the wireless network;
configuring code configured to cause at least one of said at least one processor to configure, through the onboarding GUI based on information retrieved from one or more registration databases, the network slicing topology;
defining code configured to cause at least one of said at least one processor to define, through the onboarding GUI, one or more network slice workflows based on the configuring;
generating code configured to cause at least one of said at least one processor to generate, through the onboarding GUI, a network slice bundle based on the one or more network slice workflows; and
registering code configured to cause at least one of said at least one processor to register, through the onboarding GUI, the network slice bundle with the one or more registration databases for deployment of the network slice on the wireless network.

9. The apparatus according to claim 8, wherein the one or more registration databases includes a network service registry, and wherein the configuring code further includes:
retrieving code configured to cause at least one of said at least one processor to retrieve, from the network service registry, one or more network services for the network slicing topology; and
receiving code configured to cause at least one of said at least one processor to receive, from the onboarding GUI for the one or more network nodes in the network slicing topology, a selection of one or more network services from the retrieved one or more network services.

10. The apparatus according to claim 9, wherein the one or more registration databases includes a configuration parameters registry, and wherein the configuring code further comprises:
retrieving code configured to cause at least one of said at least one processor to retrieve, from the configuration parameters registry, one or more configuration parameters for the selected one or more network services; and
receiving code configured to cause at least one of said at least one processor to receive, from the onboarding GUI, a selection of one or more configuration parameters from the retrieved one or more configuration parameters.

11. The apparatus according to claim 10, wherein the defining further includes specifying code configured to cause at least one of said at least one processor to specify a timing of utilizing the selected one or more configuration parameters for a corresponding selected network service.

12. The apparatus according to claim 8, wherein the one or more databases include a workflow registry, and wherein the defining code further includes:
retrieving code configured to cause at least one of said at least one processor to retrieve, from the workflow registry, one or more predefined workflows; and
assigning code configured to cause at least one of said at least one processor to assign at least one of the one or more predefined workflows to the one or more network slice workflows.

13. The apparatus according to claim 8, wherein the network slice bundle is registered with the one or more databases, and the network slice is deployed via execution of the one or more network flows specified in the network slice bundle.

14. The apparatus according to claim 8, wherein the network slicing topology includes one or more of a radio access network (RAN) domain, transport domain, and a core network domain.

15. A non-transitory computer readable medium having instructions stored therein, which when executed by a processor cause the processor to execute a method for onboarding a network slice associated with a wireless network, the method comprising:
providing an onboarding graphical user interface (GUI);
receiving, from the onboarding GUI, a network slicing topology that specifies one or more network nodes of the wireless network;
configuring, through the onboarding GUI based on information retrieved from one or more registration databases, the network slicing topology;
defining, through the onboarding GUI, one or more network slice workflows based on the configuring;
generating, through the onboarding GUI, a network slice bundle based on the one or more network slice workflows; and
registering, through the onboarding GUI, the network slice bundle with the one or more registration databases for deployment of the network slice on the wireless network.

16. The non-transitory computer readable medium according to claim 15, wherein the one or more registration databases includes a network service registry, and wherein the configuring the network slicing technology further comprises:
retrieving, from the network service registry, one or more network services for the network slicing topology; and
receiving, from the onboarding GUI for the one or more network nodes in the network slicing topology, a selection of one or more network services from the retrieved one or more network services.

17. The non-transitory computer readable medium according to claim 16, wherein the one or more registration databases includes a configuration parameters registry, and wherein the configuring the network slicing technology further comprises:
retrieving, from the configuration parameters registry, one or more configuration parameters for the selected one or more network services; and
receiving, from the onboarding GUI, a selection of one or more configuration parameters from the retrieved one or more configuration parameters.

18. The non-transitory computer readable medium according to claim 17, wherein the defining the one or more network slice workflows further comprises specifying a timing of utilizing the selected one or more configuration parameters for a corresponding selected network service.

19. The non-transitory computer readable medium according to claim 15, wherein the one or more databases include a workflow registry, and wherein the defining the one or more network slice workflows further comprises:
retrieving, from the workflow registry, one or more predefined workflows; and
assigning at least one of the one or more predefined workflows to the one or more network slice workflows.

20. The non-transitory computer readable medium according to claim 15, wherein the network slice bundle is registered with the one or more databases, and the network slice is deployed via execution of the one or more network flows specified in the network slice bundle.
